(19) United States
(12) Patent Application Publication
(10) Pub. No.: US 2004/0103139 A1
(43) Pub. Date: May 27, 2004

(54) Distributed processing system having sensor based data collection and associated method

(75) Inventors: Edward A. Hubbard, Round Rock, TX (US); Chris Crafford, Round Rock, TX (US)

Correspondence Address: Kelly K. Kordzik, Winstead Sechrest & Minick P.C., P.O. Box 50784, 1201 Main Street, Dallas, TX, 75250-0784, US

(73) Assignee: United Devices, Inc., Austin, TX

(21) Appl. No.: 10/687,210

(22) Filed: Oct. 16, 2003

Related U.S. Application Data
(63) Continuation-in-part of application No. 09/539,448, filed on Mar. 30, 2000.
(63) Continuation-in-part of application No. 09/603,740, filed on Jun. 23, 2000.
(63) Continuation-in-part of application No. 09/648,832, filed on Aug. 25, 2000.
(63) Continuation-in-part of application No. 09/794,969, filed on Feb. 27, 2001.
(63) Continuation-in-part of application No. 09/834,785, filed on Apr. 13, 2001.

(51) Int. Cl. G06F 15/16; G06F 15/173; G06F 17/60

(52) U.S. Cl. 709/201; 705/14; 709/226

(57) ABSTRACT

A sensor-based network hosted on a distributed computing platform and associated method are disclosed. The distributed computing platform takes advantage of unused capabilities of internet, intranet, wireless or otherwise network connected client systems, such as personal computers, internet appliances, notebook computers, server systems, storage devices or any other connected computing device. One capability for many of these devices is the ability to provide the infrastructure support for sensors, such as power, communication services, recording, data logging services and other supporting services that would allow the sensor to gather data and provide and/or communicate that data in a useful and timely manner. Such sensors can interface to these devices using a variety of communication techniques, and these sensors can be a single set or multiple sets of sensor devices associated with each device. These sensors can take on a wide variety of forms and purposes, including but not limited to sensors for weather related measurements, atmospheric conditions, air/water/environmental conditions, seismic activity, location information (such as GPS data), biological conditions, health conditions, and chemical contamination measurements.

### CROSS-REFERENCE TO RELATED APPLICATIONS

This application is a continuation-in-part application of the following co-pending applications: application Ser. No. 09/539,448 entitled “CAPABILITY-BASED DISTRIBUTED PARALLEL PROCESSING SYSTEM AND ASSOCIATED METHOD,” filed Mar. 30, 2000; application Ser. No. 09/603,740 entitled “METHOD OF MANAGING WORKLOADS AND ASSOCIATED DISTRIBUTED PROCESSING SYSTEM,” filed Jun. 23, 2000; application Ser. No. 09/648,832 entitled “SECURITY ARCHITECTURE FOR DISTRIBUTED PROCESSING SYSTEMS AND ASSOCIATED METHOD,” filed Aug. 25, 2000; application Ser. No. 09/794,969 entitled “SYSTEM AND METHOD FOR MONITORING NETWORK CONNECTED USER BASES UTILIZING DISTRIBUTED PROCESSING SYSTEMS,” filed Feb. 27, 2001; application Ser. No. 09/834,785 entitled “SOFTWARE-BASED NETWORK ATTACHED STORAGE SERVICES HOSTED ON MASSIVELY DISTRIBUTED PARALLEL COMPUTING NETWORKS,” filed Apr. 13, 2001, which are hereby incorporated by reference in its entirety.

### TECHNICAL FIELD

This invention relates to utilizing the capabilities of massively distributed devices through distributed processing computing platform. This invention is also related to sensor networks.

### BACKGROUND INFORMATION

The number of distributed devices that are connected at some point into communication networks, such as the Internet, is extremely large. The capabilities of these distributed devices, such as personal computers, are often unused by the owner or manager of the devices. These capabilities, for example with a personal computer, can include any of a variety of processing devices that are internally or externally attached to the personal computer. The co-pending applications referenced above (which are commonly owned by United Devices, Inc.) provide example details for taking advantage of these capabilities to form a distributed computing platform of network-connected computing devices.

Using sensors to gather information typically involves providing a sensor, a platform for the sensor to receive power, communication services, recording and data logging services and other supporting services that allow the sensor to gather data and to provide and/or communicate the data in a useful format. Prior sensor networks have typically relied upon dedicated sensor devices that are capable of communicating sensor data through a network to a central server and data storage devices. Example sensor networks are those that have been directed to monitoring security sensors, such as home smoke detectors and patient health monitoring devices. However, the dedicated sensor devices that are utilized typically take the form of stand-alone, single purpose devices.

There is, therefore, a need for a method and a system for a sensor based distributed processing system that can be configured for remote sensor based data collection, using remote distributed devices coupled through a network and managed by a configuration server.

### SUMMARY OF THE INVENTION

The present invention provides a sensor based network hosted on a distributed computing platform and associated method. The distributed computing platform takes advantage of unused capabilities of internet, intranet, wireless or otherwise network connected personal computers, internet appliances, notebook computers, servers, storage devices or any other connected computing device. One such capability as recognized by the present invention is the ability to provide the infrastructure support for sensors, such as power, communication services, recording, data logging services and other supporting services that would allow the sensor to gather data and provide and/or communicate that data in a useful and timely manner. In one example configuration, a sensor interfaces to a personal computer through network connections (wired and/or wireless), serial ports, USB ports or other communication ports and contains a single sensor, a single set of sensors, multiple sets of sensor devices or any other sensor configuration, as desired. These sensors can take on a wide variety of forms and purposes, including but not limited to sensors for weather related measurements, atmospheric conditions, air/water/environmental conditions, seismic activity, location information (such as GPS data), biological conditions, health conditions, and chemical measurements.

The foregoing has outlined rather broadly the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1A is a block diagram for a distributed processing system having client capability and incentive features;

FIG. 1B is a block diagram for information flow among customer systems, server systems and client systems;

FIG. 1C is a block diagram of an alternative representation for a distributed processing system;

FIG. 2 is a block diagram for processing elements within a client system;

FIG. 3A is a block diagram for a server system according to the present invention, including a control system, a workload database, and a database of client capabilities balancing vectors;

FIG. 3B is a functional block diagram for client capabilities balancing of workloads according to the present invention;

FIG. 4A is a block diagram of a distributed processing system that allows customers to select client system attributes;

FIG. 4B is a block flow diagram for client system attribute selection;

FIG. 5 is a block diagram of an alternative representation of an interconnection fabric for a distributed processing system environment;

FIG. 6 is a block diagram for a sensor based network hosted on a distributed computing platform;

FIG. 7 is a block diagram of a sensor based distributed processing system according to another embodiment of the present invention; and

FIG. 8 is a flow diagram of method steps used in embodiments of the present invention.

### DETAILED DESCRIPTION

In the following description, numerous specific details are set forth to provide a thorough understanding of the present invention. However, it will be obvious to those skilled in the art that the present invention may be practiced without such specific details. In other instances, well-known circuits may be shown in block diagram form in order not to obscure the present invention in unnecessary detail. For the most part, details concerning timing, data formats within communication protocols, and the like have been omitted inasmuch as such details are not necessary to obtain a complete understanding of the present invention and are within the skills of persons of ordinary skill in the relevant art.

Refer now to the drawings wherein depicted elements are not necessarily shown to scale and wherein like or similar elements are designated by the same reference numeral through the several views. In the following, a convergence of an iteration means that the variable being calculated differs from a previous calculated value by a known, small percentage, for example, a few percent depending on the accuracy desired. In the following, a group of logic circuits that perform a certain function may be referred to as a circuit macro or simply a macro.

The present invention is a sensor based network hosted on a distributed computing platform. As discussed below, the distributed computing platform takes advantage of unused capabilities of a wide variety of network connected processing devices to accomplish processing and/or other desired tasks. One capability as recognized by the present invention is the ability to provide the infrastructure support for sensors, such as power, communication services, recording, data logging services and other supporting services that would allow the sensor to gather data and provide and/or communicate that data in a useful and timely manner. Such sensors may interface to a personal computer through a variety of techniques, including network connections (wired and/or wireless), serial ports, USB ports or other communication ports and contains a single or multiple sets of sensor devices. These sensors can take on a wide variety of forms and purposes, including but not limited to sensors for weather related measurements, atmospheric conditions, air/water/environmental conditions, seismic activity, location information (such as GPS data), biological conditions, health conditions, and chemical measurements. Sensor types may also include radio frequency (RF) identification (ID) transmitters and receivers. Sensors types may also include optoelectronic sensors. Additionally the sensors have a way to determine their location. This may include a user entering a location address for a sensor that is accessible when data for the sensor is acquired. Sensors may also have corresponding location sensors (L-sensor) which generate location data (L-data) defining the location of a sensor. The L-data is accessible when data from the sensor is acquired. L-sensors may be global positioning (GPS) sensors.

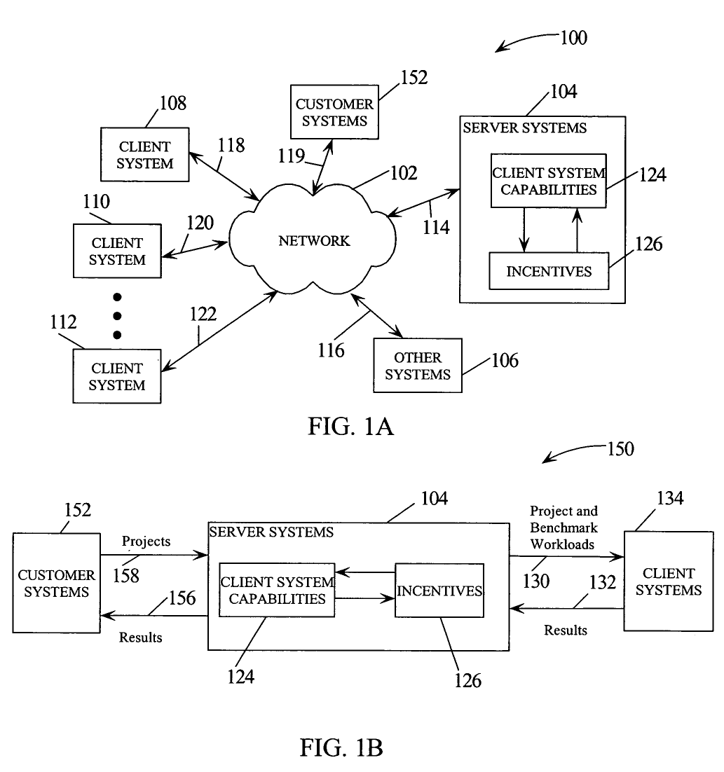

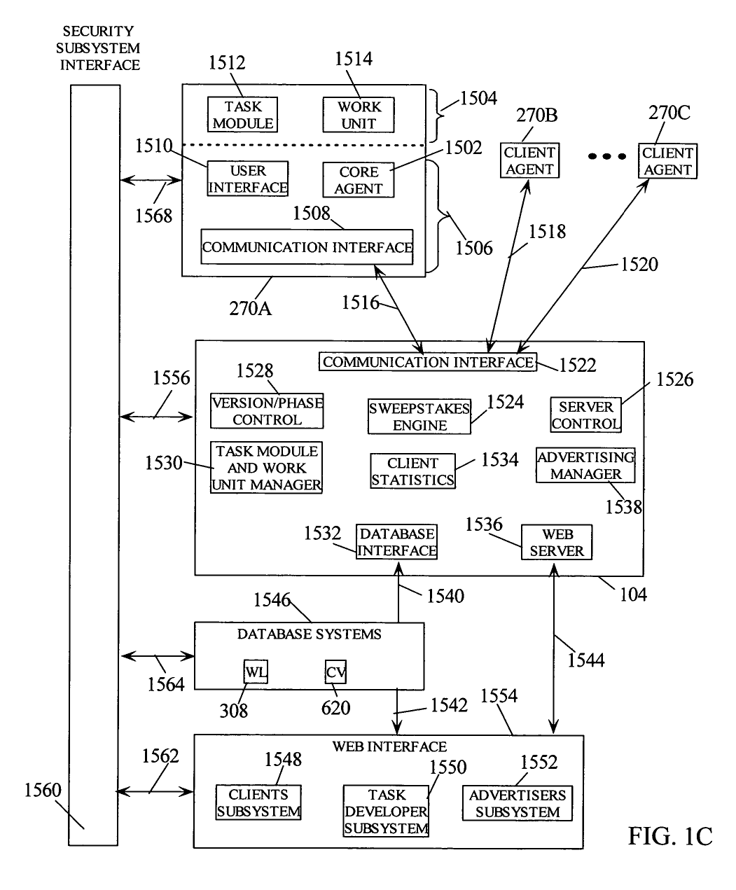

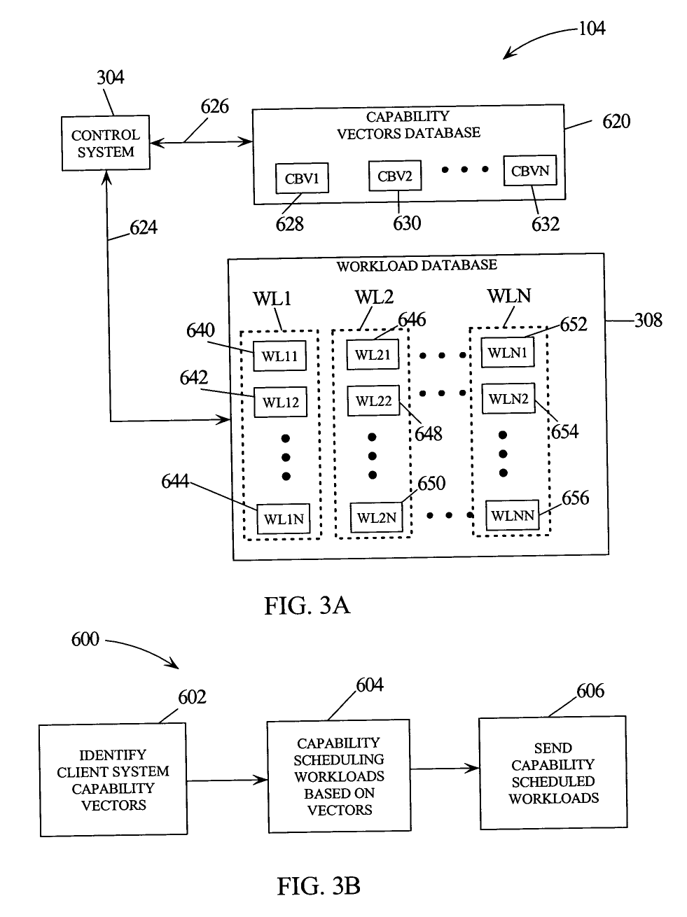

Example embodiments for the sensor based network hosted on a distributed computing platform is described with respect to FIG. 3A. First, however, with respect to FIGS. 1A, 1B, 1C, 2, 3A, 3B, 4A, 4B and 5, example distributed computing environments and example client systems are described, including client system selection based upon capabilities, attributes and components. Such distributed computing environments utilizing network-connected computing devices are described in more detail in co-pending applications identified and incorporated by reference above.

As described more fully therein, distributed processing systems according to the present invention may identify the capabilities of distributed devices connected together through a wide variety of communication systems and networks and then utilize these capabilities to accomplish network site testing objectives of the present invention. For example, distributed devices connected to each other through the Internet, Internet 2, an intranet network, a wide area network, a local area network, a wireless network, home networks, or any other network may provide any of a number of useful capabilities to third parties once their respective capabilities are identified, organized, and managed for a desired task. These distributed devices may be connected personal computer systems (PCs), internet appliances, notebook computers, servers, storage devices, network attached storage (NAS) devices, wireless devices, hand-held devices, or any other computing device that has useful capabilities and is connected to a network in any manner. The present invention further contemplates providing an incentive, which may be based in part upon capabilities of the distributed devices, to encourage users and owners of the distributed devices to allow the capabilities of the distributed devices to be utilized in the distributed parallel processing system of the present invention.

The number of usable distributed devices contemplated by the present invention is preferably very large. Unlike a small local network environment, for example, which may include less than 100 interconnected computer systems, the present invention may utilize a multitude of widely distributed devices to provide a massively distributed processing system. The Internet is an example of an interconnected system that includes a multitude of widely distributed devices. An intranet system at a large corporation is an example of an interconnected system that includes a multiplicity of distributed devices. If multiple corporate sites are involved, the distributed devices may be widely separated. A distributed processing system that utilizes such a multiplicity of widely distributed devices is available on the Internet or in a large corporate intranet and represents a massively distributed processing system according to the present invention.

Looking now to FIG. 1A, a block diagram is depicted for a distributed parallel processing system 100 according to one embodiment of the present invention. The network 102 is shown having a cloud outline to indicate the unlimited and widely varying nature of the network and of attached client types. For example, the network 102 may be the Internet, Internet 2, an internal company intranet, a local area network (LAN), a wide area network (WAN), a wireless network, a home network or any other system that connects together multiple systems and devices. In addition, network 102 may include any of these types of connectivity systems by themselves or in combination, for example, computer systems on a company intranet connected to computer systems on the Internet.

FIG. 1A also shows client systems 108, 110 . . . 112 connected to the network 102 through communication links 118, 120 . . . 122, respectively. In addition, server systems 104, other systems 106, and customer systems 152 are connected to the network 102 through communication links 114, 116 and 119, respectively. The client system capabilities block 124 is a subset of the server systems 104 and represents a determination of the capabilities of the client systems 108, 110 . . . 112. These client system capabilities, which may be stored in a capabilities database as part of the server systems 104, may be used by the server systems 104 to schedule project workloads, such as a database workload as further discussed below, for the client systems 108, 110 . . . 112. The incentives block 126 is also a subset of the server systems 104 and represents an incentive provided to the users or owners of the client systems 108, 110 . . . 112 for allowing capabilities of the client systems 108, 110 . . . 112 to be utilized by the distributed processing system 100. These client system incentives, which may be stored in an incentives database as part of the server systems 104, may be used by the server systems 104 to encourage client systems to be utilized for objectives of the distributed processing system 100.

It is noted that the client systems 108, 110 and 112 represent any number of systems and/or devices that may be identified, organized and utilized by the server systems 104 to accomplish a desired task, for example, personal computer systems (PCs), internet appliances, notebook computers, servers, storage devices, network attached storage (NAS) devices, wireless devices, hand-held devices, or any other computing device that has useful capabilities and is connected to a network in any manner. The server systems 104 represent any number of processing systems that provide the function of identifying, organizing and utilizing the client systems to achieve the desired tasks.

The incentives provided by the incentives block 126 may be any desired incentive. For example, the incentive may be a sweepstakes in which entries are given to client systems 108, 110 . . . 112 that are signed up to be utilized by the distributed processing system 100. Other example incentives are reward systems, such as airline frequent-flyer miles, purchase credits and vouchers, payments of money, monetary prizes, property prizes, free trips, time-share rentals, cruises, connectivity services, free or reduced cost Internet access, domain name hosting, mail accounts, participation in significant research projects, achievement of personal goals, or any other desired incentive or reward.

As indicated above, any number of other systems may also be connected to the network 102. The element 106, therefore, represents any number of a variety of other systems that may be connected to the network 102. The other systems 106 may include ISPs, web servers, university computer systems, and any other distributed device connected to the network 102, for example, personal computer systems (PCs), internet appliances, notebook computers, servers, storage devices, network attached storage (NAS) devices, wireless devices, hand-held devices, or any other connected computing device that has useful capabilities and is connected to a network in any manner. The customer systems 152 represents customers that have projects for the distributed processing system, as further described with respect to FIG. 1B. The customer systems 152 connect to the network 102 through the communication link 119.

It is noted that the communication links 114, 116, 118, 119, 120 and 122 may allow for communication to occur, if desired, between any of the systems connected to the network 102. For example, client systems 108, 110 . . . 112 may communicate directly with each other in peer-to-peer type communications. It is further noted that the communication links 114, 116, 118, 119, 120 and 122 may be any desired technique for connecting into any portion of the network 102, such as, Ethernet connections, wireless connections, ISDN connections, DSL connections, modem dial-up connections, cable modem connections, fiber optic connections, direct T1 or T3 connections, routers, portal computers, as well as any other network or communication connection. It is also noted that there are any number of possible configurations for the connections for network 102, according to the present invention. The client system 108 may be, for example, an individual personal computer located in someone's home and may be connected to the Internet through an Internet Service Provider (ISP). Client system 108 may also be a personal computer located on an employee's desk at a company that is connected to an intranet through a network router and then connected to the Internet through a second router or portal computer. Client system 108 may further be personal computers connected to a company's intranet, and the server systems 104 may also be connected to that same intranet. In short, a wide variety of network environments are contemplated by the present invention on which a large number of potential client systems are connected.

FIG. 1B is a block diagram for an information flow 150 among customer systems 152, server systems 104 and client systems 134, for an exemplary distributed processing system environment. The server systems 104, as discussed above, may include any number of different subsystems or components, as desired, including client system capabilities block 124 and incentives block 126. The server systems 104 send project and benchmark workloads 130 to client systems 134. A benchmark workload refers to a standard workload that may be used to determine the relative capabilities of the client systems 134. A project workload refers to a workload for a given project that is desired to be completed. Client systems 134, as discussed above, may be any number of different systems that are connected to the server systems 104 through a network 102, such as client systems 108, 110 . . . 112 in FIG. 1A. The client systems 134 send results 132 back to the server systems 104 after the client systems 134 complete processing any given workload. Depending upon the workload project, the server systems 104 may then provide results 156 to customer systems 152. The customer systems 152 may be, for example, an entity that desires a given project to be undertaken, and if so, provides the project details and data 158 to the server systems 104.

It is noted, therefore, that the capabilities for client systems 108, 110 . . . 112 may span the entire range of possible computing, processing, storage and other subsystems or devices that are connected to a system connected to the network 102. For example, these subsystems or devices may include: central processing units (CPUs), digital signal processors (DSPs), graphic processing engines (GPEs), hard drives (HDs), memory (MEM), audio subsystems (ASs), communication subsystems (CSs), removable media types (RMs), and other accessories with potentially useful unused capabilities (OAs). In short, for any given computer system connected to a network 102, there exists a variety of capabilities that may be utilized by that system to accomplish its direct tasks. At any given time, however, only a fraction of these capabilities are typically used on the client systems 108, 110 . . . 112.

As indicated above, to encourage owners or users of client systems to allow their system capabilities to be utilized by control system 104, an incentive system may be utilized. This incentive system may be designed as desired. Incentives may be provided to the user or owner of the clients systems when the client system is signed-up to participate in the distributed processing system, when the client system completes a workload for the distributed processing system, or any other time during the process. In addition, incentives may be based upon the capabilities of the client systems, based upon a benchmark workload that provides a standardized assessment of the capabilities of the client systems, or based upon any other desired criteria.

Security subsystems and interfaces (not shown) may also be included to provide for secure interactions between the various devices and systems of the distributed processing system 100. The security subsystems and interfaces operate to secure the communications and operations of the distributed processing system. This security subsystem and interface also represents a variety of potential security architectures, techniques and features that may be utilized. This security may provide, for example, authentication of devices when they send and receive transmissions, so that a sending device verifies the authenticity of the receiving device and/or the receiving device verifies the authenticity of the sending device. In addition, this security may provide for encryption of transmissions between the devices and systems of the distributed processing system. The security subsystems and interfaces may also be implemented in a variety of ways, including utilizing security subsystems within each device or security measures shared among multiple devices, so that security is provided for all interactions of the devices within the distributed processing system. In this way, for example, security measures may be set in place to make sure that no unauthorized entry is made into the programming or operations of any portion of the distributed processing system including the client agents.

FIG. 1C is a block diagram of an alternative representation for a distributed processing system, according to an alternate embodiment of the present invention. Server systems 104, database systems 1546 and web interface 1554 are coupled together through communication links 1540, 1542 and 1544. The web interface 1554 includes clients subsystem 1548, task developer subsystem 1550, and advertisers subsystem 1552, and may include other subsystems as desired. The database systems 1546 include workload (WL) information 308, client capability vector (CV) information 620, and any other stored information as desired. Server systems 104 include various modules and subsystems, including database interface 1532, web server 1536, task module and work unit manager 1530, client statistics module 1534, advertising manager 1538, task module version/phase control subsystem 1528, sweepstakes engine 1524, server control subsystem 1526, and communication interface 1522. It is noted that in the embodiment of a distributed processing system 100 as depicted in FIG. 1C, the three primary operations for the server systems 104, database systems 1546 and web interface 1554 are directed to managing, processing and providing an interface for client systems, customer tasks, and customer advertising.

As discussed above, each client system includes a client agent that operates on the client system and manages the workloads and processes of the distributed processing system. As shown in FIG. 1C, each of the client agents 270A, 270B . . . 270C communicates with the server systems 104 through communication links 1516, 1518 . . . 1520, respectively. As discussed above, any number of different techniques and architectures may be utilized to provide these communication links. In the embodiment as shown in FIG. 1C with respect to client agent 270A, each client agent includes a base distributed processing system component 1506 and a separate project or workload component 1504. As depicted, a communication interface 1508, a core agent module 1502, and a user interface 1510 make up the base distributed processing system component 1506. The task module 1512 and the work unit 1514 make up the separate project or workload component 1504. The task module 1512 operates on top of the core agent module 1502 to provide processing of each project work unit 1514. It is noted that different or additional modules, subsystems or components may be included within the client agent, as desired. For example, a personal computer screen saver component may be part of the base distributed processing system component 1506 or the separate project or workload component 1504.

Also as discussed above, security subsystems and interfaces may be included to provide for secure interactions between the various devices and systems of the distributed processing system 100. As depicted in FIG. 1C, a security subsystem and interface 1560 is interconnected with the server systems 104, the database systems 1546, the web interface 1554, and the client agents 270A, 270B . . . 270C. These interconnections are represented by lines 1556, 1564, 1562, and 1568, respectively. The security subsystem and interface 1560 operates to secure the communications and operations of the distributed processing system 100. This security subsystem and interface 1560 also represents a variety of potential security architectures, techniques and features that may be utilized. This security may provide, for example, authentication of devices when they send and receive transmissions, so that a sending device verifies the authenticity of the receiving device and/or the receiving device verifies the authenticity of the sending device. In addition, this security may provide for encryption of transmissions between the devices and systems of the distributed processing system 100. The security subsystem and interface 1560 may also be implemented in a variety of ways, including utilizing security subsystems within each device or security measures shared among multiple devices, so that security is provided for all interactions of the devices within the distributed processing system 100. In this way, for example, security measures may be set in place to make sure that no unauthorized entry is made into the programming or operations of any portion of the distributed processing system 100 including the client agents 270A, 270B . . . 270C.

In operation, client systems or end-users may utilize the client subsystem 1548 within the web interface 1554 to register, set user preferences, check statistics, check sweepstakes entries, or accomplish any other user interface option made available, as desired. Advertising customers may utilize the advertiser's subsystem 1552 within the web interface 1554 to register, add or modify banner or other advertisements, set up rules for serving advertisements, check advertising statistics (e.g., click statistics), or accomplish any other advertiser interface option made available, as desired. Customers and their respective task or project developers may utilize the task developer subsystem 1550 to access information within database systems 1546 and modules within the server systems 104, such as the version/phase control subsystem 1528, the task module and work unit manager 1530, and the workload information 308. Customers may also check project results, add new work units, check defect reports, or accomplish any other customer or developer interface option made available, as desired.

Advantageously, the customer or developer may provide the details of the project to be processed, including specific program code and algorithms that will process the data, in addition to any data to be processed. In the embodiment shown in FIG. 1C, this program code takes the form of a task module 1512 within the workload, while the data takes the form of work unit 1514. These two portions make up the project or workload component 1504 of each client agent 270. For a given project, the task module 1512 will likely remain relatively constant, except for version updates, patches or phase modifications, while the work unit 1514 will likely change each time processing of the data that it represents is completed. The project or workload component 1504 runs in conjunction with the base distributed processing system component 1506. When a different customer or project is started on a given client system, the project or workload component 1504 will typically be replaced, while the base distributed processing system component 1506 will likely remain relatively constant, except for version updates, patches or other modifications made for the distributed processing system.

Information sent from the server systems 104 to the client agents 270A, 270B . . . 270C may include task modules, data for work units, and advertising information. Information sent from the client agents 270A, 270B . . . 270C to the server systems 104 may include user information, system information and capabilities, current task module version and phase information, and results. The database systems 1546 may hold any relevant information desired, such as workload information (WL) 308 and client capability vectors (CV) 620. Examples of information that may be stored include user information, client system information, client platform information, task modules, phase control information, version information, work units, data, results, advertiser information, advertisement content, advertisement purchase information, advertisement rules, or any other pertinent information.

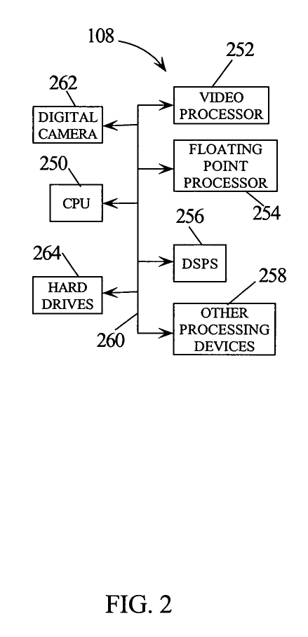

FIG. 2 is a block diagram for processing elements within a client system 108 according to the present invention. In this diagram, client system 108 is contemplated as a personal computer. In a personal computer, an internal bus 260 would typically have a variety of different devices connected to it. For example, a CPU 250 could be connected through the bus 260 to a video processor 252, a floating point processor 254 (often integrated within the CPU itself), and digital signal processors 256 (DSPs), such as those found on sound cards and modems. In addition, any of a variety of other processing devices 258 may be included. Furthermore, other types of devices may be connected, such as hard drives 264, which provide disk storage capabilities, and a digital camera 262.

It is noted, therefore, that the capabilities for client systems 108, 110 . . . 112 may span the entire range of possible computing, processing, storage and other subsystems or devices that are connected to a system connected to the network 102. For example, these subsystems or devices may include: central processing units (CPUs), digital signal processors (DSPs), graphic processing engines (GPEs), hard drives (HDs), memory (MEM), audio subsystems (ASs), communication subsystems (CSs), removable media types (RMs), and other accessories with potentially useful unused capabilities (OAs). In short, for any given computer system connected to a network 102, there exists a variety of capabilities that may be utilized by that system to accomplish its direct tasks. At any given time, however, only a fraction of these capabilities are typically used on the client systems 108, 110 . . . 112. The present invention can take advantage of these unused capabilities.

FIG. 3A is a block diagram for a server system 104 according to the present invention, including a control system 304, a workload database 308, and a database of capability vectors 620. The workload database 308 includes a variety of sets of workload projects WL1, WL2 . . . WLN. For each workload project, there may be multiple workload units. For example, workload project WL1 includes workload units WL11, WL12 . . . WL1N, as represented by elements 640, 642 . . . 644, respectively. Similarly, workload project WL2 includes workload units WL21, . . . L22 . . . WL2N, as represented by elements 646, 648 . . . 650, respectively and workload project WLN includes workload units WLN1, WLN2 . . . WLNN, as represented by elements 652, 654 . . . 656, respectively. Control system 304 accesses the workload units via line 624

It may be expected that different workload projects WL1, WL2 . . . WLN within the workload database 308 may require widely varying processing requirements. Thus, in order to better direct resources to workload projects, the server system may access various system vectors when a client system signs up to provide processing time and other system or device capabilities to the server system. This capability scheduling helps facilitate project operation and completion. In this respect, the capability vector database 620 keeps track of any desired feature of client systems or devices in capability vectors CBV1, CBV2 . . . CBVN, represented by elements 628, 630 . . . 632, respectively. These capability vectors may then be utilized by the control system 304 through line 626 to capability balance workloads.

This capability scheduling according to the present invention, therefore, allows for the efficient management of the distributed processing system of the present invention. This capability scheduling and distribution will help maximize throughput, deliver timely responses for sensitive workloads, calculate redundancy factors when necessary, and in general, help optimize the distributed processing computing system of the present invention. The following TABLE 1 provides lists of capability vectors or factors that may be utilized. It is noted that this list is an example list, and any number of vectors or factors may be identified and utilized, as desired.

TABLE 1
Example Client Capability Vectors or Factors

| 1. BIOS Support: | | a. | BIOS Type (brand) |
|---|---|---|---|
| b. | ACPI | c. | S1, S2, S3, and S4 sleep/wake |
| | | | states |
| d. | D1, D2 and D3 ACPI device | e. | Remote Wake Up Via Modem |
| | states | | |
| f. | Remote Wake Up Via | g. | CPU Clock control |
| | Network | | |
| h. | Thermal Management control | i. | Docked/Undocked state control |
| j. | APM 1.2 support | k. | Hotkey support |
| l. | Resume on Alarm, Modem | m. | Password Protected Resume |
| | Ring and LAN | | from Suspend |
| n. | Full-On power mode | o. | APM/Hardware Doze mode |
| p. | Stand-by mode | q. | Suspend to DRAM mode |
| r. | Video Logic Power Down | s. | HDD, FDD and FDC Power |
| | | | Down |
| t. | Sound Chip Power Down | u. | Super I/O Chip Power Down |
| 2. CPU Support: | | a. | CPU Type (brand) |
| b. | MMX instruction set | c. | SIMD instruction set |
| d. | WNI instruction set | e. | 3DNow instruction set |
| f. | Other processor dependent | g. | Raw integer performance |
| | instruction set(s) | | |
| h. | Raw FPU performance | i. | CPU L1 data cache size |
| j. | CPU L1 instruction cache size | k. | CPU L2 cache size |
| l. | CPU speed (MHz/GHz . . . ) | m. | System bus (MHz/GHz . . . ) |
| | | | speed supported |
| n. | Processor Serial Number | o. | CPUID |
| 3. Graphic Support | | a. | Graphics type (brand) |
| b. | # of graphics engines | c. | Memory capacity |
| d. | OpenGL support | e. | Direct3D/DirectX support |
| f. | Color depth supported | g. | MPEG 1/II decode assist |
| h. | MPEG1/II encode assist | i. | OS support |
| j. | Rendering type(s) supported | k. | Single-Pass Multitexturing |
| | | | support |
| l. | True Color Rendering | m. | Triangle Setup Engine |
| n. | Texture Cache | o. | Bilinear/Trilinear Filtering |
| p. | Anti-aliasing support | q. | Texture Compositing |
| r. | Texture Decompression | s. | Perspectively Correct Texture |
| | | | Mapping |
| t. | Mip-Mapping | u. | Z-buffering and Double- |
| | | | buffering support |
| v. | Bump mapping | w. | Fog effects |
| x. | Texture lighting | y. | Video texture support |
| z. | Reflection support | aa. | Shadows support |
| 4. Storage Support | | a. | Storage Type (brand) |
| b. | Storage Type (fixed, | c. | Total storage capacity |
| | removable, etc.) | | |
| d. | Free space | e. | Throughput speed |
| f. | Seek time | g. | User dedicated space for current |
| | | | workload |
| h. | SMART capable | | |
| 5. System | | a. | System Type (brand) |
| b. | System form factor (desktop, | | |
| | portable, workstation, server, | | |
| | etc.) | | |
| 6. Communications Support | | a. | Type of Connection (brand of |
| | | | ISP) |
| b. | Type of Connection Device | c. | Hardware device capabilities |
| | (brand of hardware) | | |
| d. | Speed of connection | e. | Latency of connection |
| f. | Round trip packet time of | g. | Number of hops on connection |
| | connection | | type |
| h. | Automatic connection support | i. | Dial-up only (yes/no) |
| | (yes/no) | | |
| j. | Broadband type (brand) | k. | Broadband connection type |
| | | | (DSL/Sat./Cable/T1/Intranet/ |
| | | | etc.) |
| 7. Memory | | a. | Type of memory error |
| | | | correction (none, ECC, etc.) |
| b. | Type of memory supported | c. | Amount of total memory |
| | (EDO, SDRAM, RDRAM, | | |
| | etc.) | | |
| d. | Amount of free memory | e. | Current virtual memory size |
| f. | Total available virtual | | |
| | memory size | | |
| 8. Operating System | | a. | Type of operating system |
| | | | (brand) |
| b. | Version of operating system | c. | Health of operating system |
| 9. System application software | | a. | Type of software loaded and/or |
| | | | operating on system |
| b. | Version of software | c. | Software features |
| | | | enabled/disabled |
| d. | Health of software operation | | |

FIG. 3B is a functional block diagram for capabilities determination and scheduling operation 600 for workloads in a distributed processing system according to the present invention. Initially, various vectors are identified for which capability information is desired in the “identify client system capability vectors” block 602. The server systems 104 (FIG. 3A) then balances workloads among client systems 108, 110 and 112 based upon the capability vectors in the “capability scheduling workloads based on vectors” block 604. Then the capabilities scheduled workloads are sent to the client systems for processing in the “send capability scheduled workloads” block 606.

This capability scheduling and management based upon system related vectors allows for efficient use of resources. For example, utilizing the operating system or software vectors, workloads may be scheduled or managed so that desired hardware and software configurations are utilized. This scheduling based upon software vectors may be helpful because different software versions often have different capabilities. For example, various additional features and services are included in MICROSOFT WINDOWS'98 as compared with MICROSOFT WINDOWS'95. Any one of these additional functions or services may be desired for a particular workload that is to be hosted on a particular client system device. Software and operating system vectors also allow for customers to select a wide variety of software configurations on which the customers may desire a particular workload to be run. These varied software configurations may be helpful, for example, where software testing is desired. Thus, the distributed processing system of the present invention may be utilized to test new software, data files, Java programs or other software on a wide variety of hardware platforms, software platforms and software versions. For example, a Java program may be tested on a wide proliferation of JREs (Java Runtime Engines) associated with a wide variety of operating systems and machine types, such as personal computers, handheld devices, etc.

From the customer system perspective, the capability management and the capability database, as well as information concerning users of the distributed devices, provide a vehicle through which a customer may select particular hardware, software, user or other configurations, in which the customer is interested. In other words, utilizing the massively parallel distributed processing system of the present invention, a wide variety of selectable distributed device attributes, including information concerning users of the distributed devices, may be provided to a customer with respect to any project, advertising, or other information or activity a customer may have to be processed or distributed.

For example, a customer may desire to advertise certain goods or services to distributed devices that have certain attributes, such as particular device capabilities or particular characteristics for users of those distributed devices. Based upon selected attributes, a set of distributed devices may be identified for receipt of advertising messages. These messages may be displayed to a user of the distributed device through a browser, the client agent, or any other software that is executing either directly or remotely on the distributed device. Thus, a customer may target particular machine specific device or user attributes for particular advertising messages. For example, users with particular demographic information may be targeted for particular advertisements. As another example, the client agent running on client systems that are personal computers may determine systems that are suffering from numerous page faults (i.e., through tracking operating system health features such as the number of page faults). High numbers of page faults are an indication of low memory. Thus, memory manufacturers could target such systems for memory upgrade banners or advertisements.

Still further, if a customer desires to run a workload on specific device types, specific hardware platforms, specific operating systems, etc., the customer may then select these features and thereby select a subset of the distributed client systems on which to send a project workload. Such a project would be, for example, if a customer wanted to run a first set of simulations on personal computers with AMD ATHLON microprocessors and a second set of simulations on personal computers with INTEL PENTIUM III microprocessors. Alternatively, if a customer is not interested in particular configurations for the project, the customer may simply request any random number of distributed devices to process its project workloads.

Customer pricing levels for distributed processing may then be tied, if desired, to the level of specificity desired by a particular customer. For example, a customer may contract for a block of 10,000 random distributed devices for a base amount. The customer may later decide for an additional or different price to utilize one or more capability vectors in selecting a number of devices for processing its project. Further, a customer may request that a number of distributed devices be dedicated solely to processing its project workloads. In short, once device attributes, including device capabilities and user information, are identified, according to the present invention, any number of customer offerings may be made based upon the device attributes for the connected distributed devices. It is noted that to facilitate use of the device capabilities and user information, capability vectors and user information may be stored and organized in a database, as discussed above.

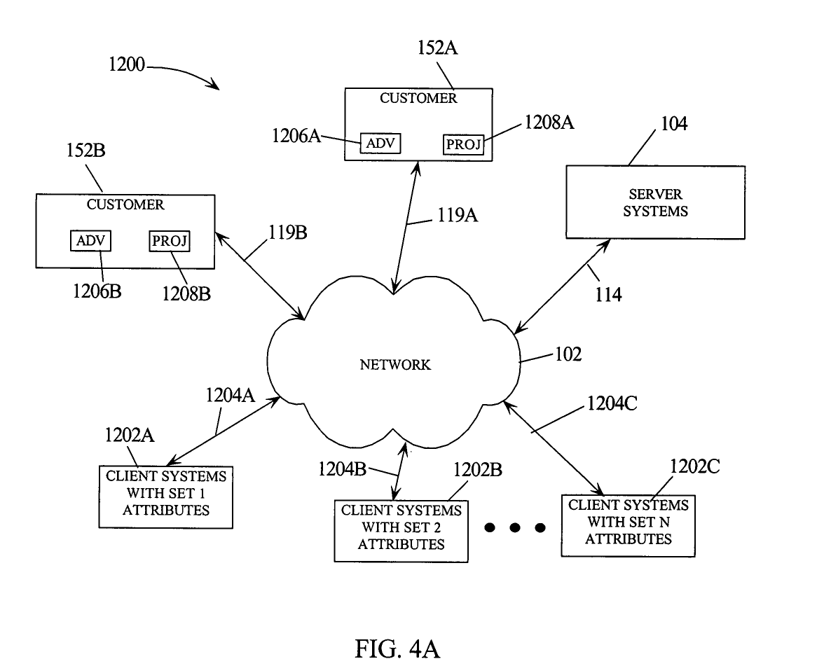

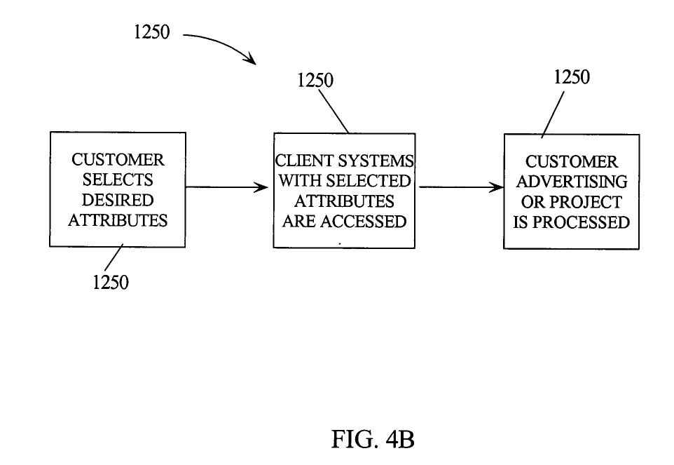

Referring now to FIG. 4A which is a block diagram that depicts a distributed processing system 1200 that allows customers to select client system attributes, such as device capabilities and user characteristics, according to the present invention. In this embodiment, the network 102 is the Internet to which server systems 104, customer 152A, customer 152B, and client systems 1202A, 1202B . . . 1202C are connected. These systems are connected through communication links 114, 119A, 119B, 1204A, 1204B . . . 1204C, respectively. As noted above, these communication links may include any of a wide variety of devices and/or communication techniques for allowing a system to interface with other connected systems.

As shown in FIG. 4A, and as discussed above, the customers 152A and 152B may desire to send information or projects, such as advertisements (ADV) 1206A and 1206B and/or projects (PROJ) 1208A and 1208B, to groups of client systems that have particular or selected capabilities. The number of different groups of client systems is as varied as the capability and user data available for those client systems. The client systems 1202A represent client systems that include a first set (Set 1) of desired attributes. The client systems 1202B represent client systems that include a second set (Set 2) of desired attributes. And the client systems 1202C represent client systems that include an Nth set (Set N) of desired attributes. Once attributes are selected, the client systems with those attributes may be accessed as desired by customers 152A and 152B. For example, customer 152A may send its advertisement to client systems 1202B. Customer 152B may send its advertisement to client systems 1202A. The project 1208A from customer 152A may be processed by client systems 1202C. And the project 1208B from customer 152B may be processed by client systems 1202B. It is noted, therefore, that any combination of desired attributes, such as device capabilities and user characteristics, may be identified and utilized to satisfy customer objectives, whether those objectives are advertising, project processing, or some other desired objective.

FIG. 4B is a block flow diagram for client system attribute selection, according to the present invention. In the embodiment shown, process 1250 begins with the customer selecting desired attributes in block 1252. Next, client systems with selected attributes are accessed in block 1254. And, then in block 1256, the customer objective, such as advertising or project, is processed by the client system. Control of this process 1250 may be provided by the server systems 104 (FIG. 4A), if desired, such that the customer interfaces with the server systems 104 to select device attributes and then the server systems 104 access the client systems. Alternatively, the server systems 104 may simply provide the customer with a list of contact information (e.g., IP addresses) for the client systems, so that the customer may directly access the client system, for example, in providing advertisements to the users of the client systems. It is further noted that other control techniques may also be used to identify and access client systems with particular desired device capabilities, user characteristics, or other device attributes, according to the client system attribute selection method of the present invention.

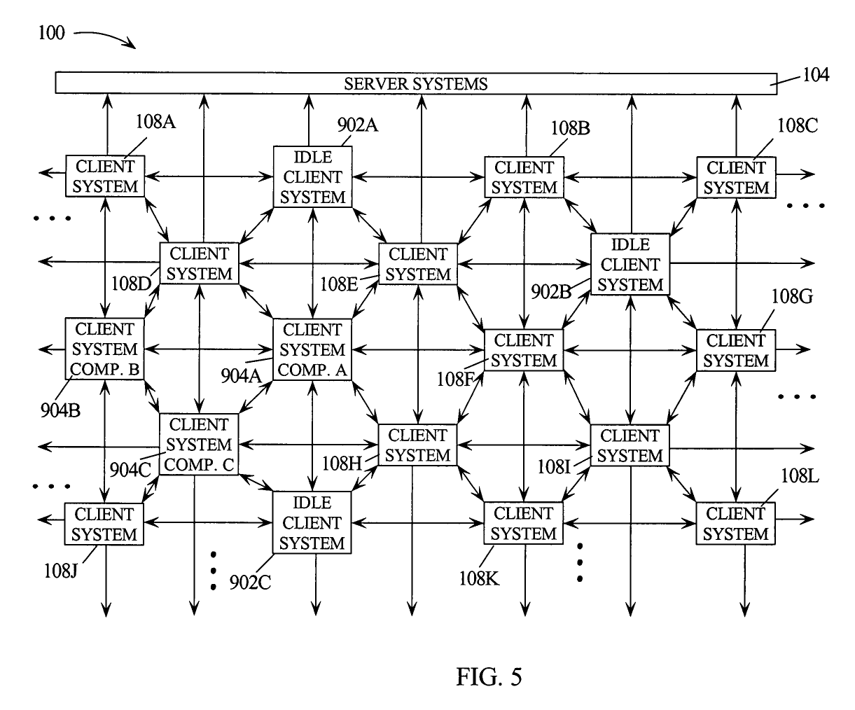

FIG. 5 is a block diagram of an alternative representation of an interconnection fabric for a distributed processing system 100, according to the present invention. In this diagram and as described above, the network environment may be the Internet, an internal company intranet, a local area network (LAN), a wide area network (WAN), a wireless network, a home network, or any other system that connects together multiple systems and devices. In addition, the server systems and client systems may be interconnected by a variety of possible connection interfaces, for example, Ethernet connections, wireless connections, ISDN connections, DSL connections, modem dial-up connections, cable modem connections, direct T1 or T3 connections, fiber optic connections, routers, portal computers, as well as any other network or communication connection. It is noted, therefore, as discussed with respect to other embodiments such as the embodiment of FIG. 1A, that systems may be coupled into an interconnected fabric in any of a variety of ways and communications can potentially occur directly or indirectly between any of the systems coupled into the fabric, as would be understood by those of skill in the art.

Within this environment, as depicted in FIG. 5, server systems 104 are interconnected with any number of client systems, for example, client systems 108A, 108B, 108C, 108D, 108E, 108F, 108G, 108H, 108I, 108J, 108K and 108L. In addition, these client systems may also include idle client systems 902A, 902B, and 902C, as discussed in more detail with respect to FIG. 9 in the applications incorporated by reference above. Furthermore, these client systems may include client system 904A with a component A, client system 904B with a component B, and client system 904C with a component C. It is also noted that the interconnection fabric may include any number of devices that are not client systems, in that they themselves are not providing components or processing capabilities for the distributed processing system of the present invention. Nevertheless, these devices may be considered part of the system because they may relay, interpret, process or otherwise transmit or receive information from or to client systems that are part of the distributed processing system.

Aggregating component level resources, according to the present invention, is discussed in the following description. As previously described, the capabilities of client systems are determined for purposes of allocating, scheduling and managing distributed processing workloads. In other words, each of the client systems may be made up of many individual subsystems with various capabilities. In some cases, it may occur that particular components on different machines may provide added value if combined (as an aggregate). Thus, utilizing subsystem or component level resources from a heterogeneous group of devices may be the most efficient or otherwise advantageous way of taking advantage of these resources to complete various desired tasks.

Referring now more particularly to FIG. 5, the client systems 904A, 904B and 904C may have component A, component B and component C, respectively, that are better utilized in combination. For example, client system 904A may have a fast processor, a high-speed network connection, but little available storage space. Client system 904B may have large amounts of available free storage space but little processing power. Client system 904C may also have a fast processor, but relatively little available storage space. In this example, a workload that requires both a large storage capacity and a fast processor may be efficiently completed by dedicating component level resources to various parts of the workload from different machines. Thus, the workload may be managed by having client systems 904A and 904C processing data stored within and transmitted from client system 904B. Once clients systems 904A and 904C process data, this results data may then be transmitted back to client system 904B where it is combined and eventually forwarded back to the server systems 104. The client system 904B, therefore, essentially acts as a server for a workload subset, sending out portions of a subset workload, receiving back the processed data, and combining the data to build a completed workload subset.

It is noted that any number of different components from different client systems may be combined, as desired. For example, for wireless devices, DSP processing and storage components could be combined with components from other client systems. For display devices, graphics rendering power could be combined. Also, low intelligence (low capability) machines, such as connected household appliances, vending machines, etc., slow-speed processing components could be combined. In short, an appropriate workload may include instructions to numerous client systems that enable collaboration and combination of component level resources. Such instructions may include directions as to where to receive input, where to send output, and ultimately which client systems return final results.

It is further noted that the control instructions may be de-centralized as well. For example, client systems may communicate directly with each other in a peer-to-peer fashion. In this way, workload communications may occur directly between client systems, and workload control and management may occur through the client system agents located on client systems.

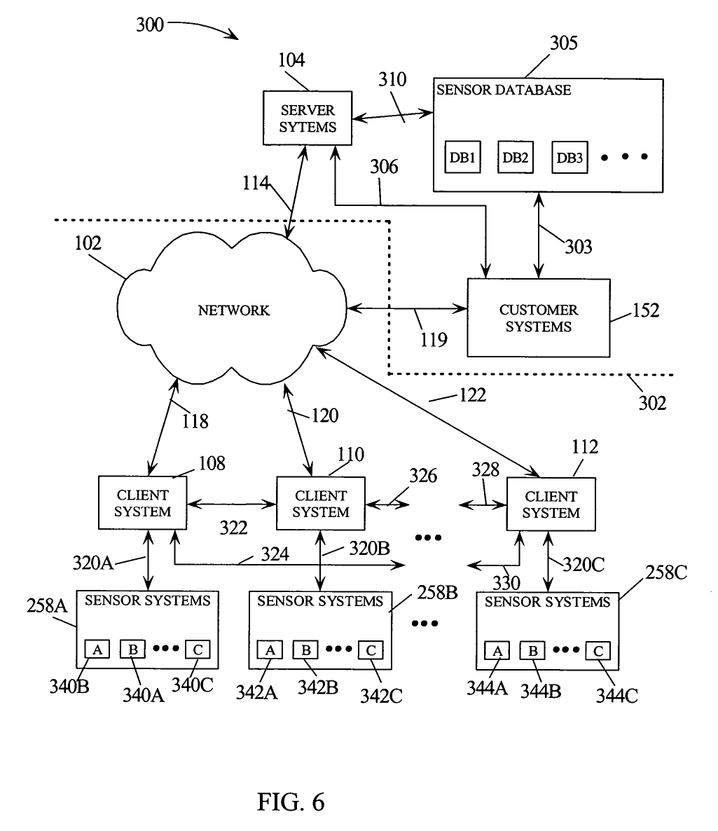

FIG. 6 is a block diagram of a sensor based distributed processing system 300 according to an embodiment of the present invention. Sensor based distributed processing system 300 is formed utilizing sensors (e.g., 340A-340C) connected to client systems (108, 110, 112) to form a system that can take advantage of sensor capabilities and attributes of these client systems as part of the distributed processing system. Thus, sensor systems 258A-258C may be connected to the client systems 108, 110 . . . 112 which are capable of detecting any of a variety of physical parameters associated with its location, function and purpose. Sensor systems 258A-258C may include sensors that are independently powered or receive their power from the client systems. Sensor systems 258A-258C may also use software within the client systems to format, convert or otherwise prepare the sensor data to be easily interpreted. Client systems (remote distributed devices), such as personal computers, are very likely capable of hosting a wide variety of sensors and may host agent software that is capable of providing sensor data back to the server systems 104 or other networked connected systems in response to a request. If desired, these sensor systems, their capabilities and their attributes can be incorporated into the distributed computing platform 100 as client system capability vectors, attributes and or components that can be utilized singularly, in combination or in aggregation, as desired. In addition to sensor data, the sensor systems have sensor identification (ID) data for identifying the sensor type.

Since it may be more useful to have sensor systems 258A-258C located remote from server systems 104 or customer systems 152, a particular client system (e.g., 108) is referred to as a remote distributed device (RDD). Sensors (240A-240C) coupled to particular RDD 108 may include at least one location sensor (L-sensor) which generates location data (L-data) defining the location of RDD 108 and more particularly the sensors 240A-240C coupled to RDD 108. Embodiments of the present invention may use other means to generated L-data. For example, L-data in the form of an address of the facility housing the RDD 108 may be entered by a user of the RDD. Likewise, a network address of RDD 108 may be used to determine L-data. Sensors (e.g., 240A-240C) may also include at least one environmental sensor (E-sensor). An E-sensor, in the present disclosure, is defined as generating environmental data (E-data) that comprises any quantifiable parameter that may be related to people, property or physical conditions in an area in proximity to and including its corresponding RDD to which it is coupled.

In addition, workload projects and work units can be formulated and utilized to manage and control the activities of the RDDs having attached E-sensors, thereby forming a sensor based distributed processing system that takes advantage of the unused processing power and capabilities of the remote distributed systems (RDDs). A distributed processing system may comprise a plurality of distributed devices (e.g., client systems 108, 110, 112) coupled through network 102 to a server 104, wherein the distributed devices may process workloads for the distributed processing system. The client systems (108, 110, 112) may not already include E-sensors (e.g., 240A-240C). In such a case, it may be desirable to provide incentives and motivations for the owners or operators of the client systems to add particular E-sensors to the client systems so the client systems may participate in a sensor based distributed processing system configured by the server in response to a request from customer systems 152. It is further noted that in an intranet environment or in some other environment where there is a level of common control over a number of client systems, the E-sensors could simply be obtained and installed based upon a decision made by the persons and/or entities possessing this common control. In any event, the distributed sensor platform of the present invention may utilize existing capabilities of distributed devices to host and operate a wide variety of E-sensor devices.

In FIG. 6 distributed processing system 300 comprises a plurality of sensor systems 258A, 258B . . . 258C, server systems 104, and client systems 108, 110 . . . 112 coupled with network 102. The client systems 108, 110 . . . 112 host the sensor systems 258A, 258B . . . 258C and communicate with them through connections, links and/or infrastructure features 320A, 320B . . . 320C. The E-sensor data (E-data) generated by sensor systems 258A, 258B . . . 258C may be received by the client systems 108, 110 . . . 112 and communicated to the server systems 104 and customer systems 152 through the network 102. The distributed processing system 300 may also include sensor database 305 that is capable of storing sensor related information, such sensor ID data, E-data, and L-data. Additionally, the client systems 108, 110 . . . 112 may communicate with each other as discussed above and as represented in FIG. 6 by links 322, 324, 326, 328 . . . 330, which can be any of a variety of different communication mechanisms or techniques. The server systems 104, the customer systems 152 and sensor database 305 may communicate with each other through communication links 303, 306 and 310, which can be any of a variety of different communication mechanisms or techniques. The communication links 114, 118, 119, 120 and 122 to network 102 may also be any of a variety of communication mechanisms or techniques.

With respect to the distributed processing system 300, network 102 may be, for example, a relatively unbounded network such as the public internet or a private intranet, or a combination thereof. In such an embodiment, the line 302 represents a delineation between a single or small group of controlled physical spaces/servers/workstations above and the entire unbounded network below. The server systems 104 and customer systems 152 may comprise related or unrelated devices, including servers, which may utilize the sensors (e.g., 240A-240C) or may themselves represent a sensor based distributed processing system. In turn, the database 305 may be related or unrelated to the server systems 104 and the customer systems 152. Database 305 may be a collection of databases (DB1, DB2 . . . DB3) that store sensor data corresponding to RDDs (client systems), where each database is associated with a sensor based distributed processing system (e.g., similar to system 300). For example, the server systems 104 could represent servers that manage and control the distributed processing system 300, and the customer systems 152 could be third party servers that are interested in utilizing the sensor systems (e.g. 258A-258C) hosted by the client systems 108, 110 . . . 112 that are part of another distributed processing system 100 (see FIG. 1A).

The client systems 108, 110 . . . 112 (RDDs) that are utilized for the distributed processing system 300 provide a platform for the sensor systems 258A, 258B . . . 258C to receive power, communication services, recording and data logging services and other supporting services that allow the sensor systems to gather data and provide and/or communicate the data in a useful format and a timely manner. In this way, the distributed processing system 300 may utilize, at least in part, unused capabilities of internet, intranet, wireless or otherwise network connected personal computers, internet appliances, notebook computers, servers, storage devices or any other connected computing device that could provide the capabilities needed to support the sensor systems. In one configuration, client systems 108, 110 . . . 112 are personal computers (PCs), and the sensor systems 258A, 258B . . . 258C may interface to a PC (e.g., client system 108) through network connections (320A) which may be wired or wireless. Connections 320A may be serial ports, parallel ports, USB ports, ISA slots, PCI slots or any other desired mechanism. Sensor systems 258A, 258B . . . 258C hosted on the network-connected client systems (RDDs) in effect become another capability, attribute, and component that may be utilized by a distributed processing system (e.g., system 100 in FIG. 1A) thereby taking advantage of unused or underutilized resources of network-connected distributed devices that were put into operation for purposes distinct from operating a client agent program to provide a sensor base distributed processing system or other project processing services.

Control, management and operation of the distributing processing system 300 may be facilitated by the server systems 104. For example, a client agent that executes within the client systems 108, 110 . . . 112 may include a sensor component as part of the task module that runs in conjunction with the core agent component of the client agent. Work units or workloads that are sent to each client system 108, 110 . . . 112 may include details for the operation of a sensor (e.g., 240A), and these operation details may be configured and selected depending upon the nature and capabilities of the sensor systems that are coupled to the client system (e.g., client system 108). As discussed above, the core agent component, the sensor component and the workloads may be provided through a download and installation process from the server systems 104 to the client systems 108, 110 . . . 112. In addition, customer systems 152 may be given a level of control to read E-data, sensor ID data, and L-data from the sensor systems and/or to provide instructions to the sensor systems concerning when to take measurements, measurement ranges, measurement precision, etc.

Each of the sensor systems 258A, 258B . . . 258C may contain any desired sensor and sensor configuration and may include a single sensor, a set of sensors or multiple sets of sensors, as desired, as represented by sensor 340A, 340B . . . 340C within sensor system 258A, sensor blocks 342A, 342B . . . 342C within sensor system 258B, and sensor 344A, 344B . . . 344C within sensor system 258C. These sensors may include, but are not limited to, environmental sensors (E-sensors) for weather related measurements, atmospheric conditions, air/water/environmental conditions, seismic activity, biological conditions, health conditions, and chemical contamination measurements. Likewise L-data may be acquired from an location sensor (L-sensor) such as global positioning system (GPS). More specifically, example E-sensors (e.g., 240A) may make measurements including:

barometric pressure, useful for weather forecasting and other sciences

temperature

environmental conditions

accelerometers, useful in gathering data on seismic activity

altimeter data

air quality, useful for measuring indoor and, with extensions, outdoor air quality

water quality

biological and chemical defense, for use in detecting and communicating potential biological terrorism and potential chemical-weapons terrorism

biological, a large category of sensors widely ranging from simple human-health sensors for measuring, for instance, blood sugar and communicating that to healthcare providers, to more complicated environmental data

chemical, useful in measuring chemicals contained in air, water, bodily fluids and other mediums in which chemical detection is important

image detection and changes in images by detecting changes in light intensity levels and/or frequency

Each sensor within the sensor systems 258A-258C may be uniquely addressable, and may report its data to servers 104 and/or customer systems 152 (and to other sensor nodes when appropriate) and may be enhanced through software that interfaces with the sensor or sensors connected to each node. In addition, the E-sensors within the sensor systems (e.g., 258A, 258B . . . 258C) from different client systems may be combined, managed and coordinated to work together, if desired. The sensor systems 258A, 258B . . . 258C may include location identification devices, such as a GPS (Global Positioning System) receiver, so that L-data from the GPS sensor may be provided along with the sensor E-data. The L-data stored within the sensor database 305 may be used by the server systems 104 in configuring a distributed sensor data collection system in response to a request from a customer system that has subscribed to a data collection service hosted by server systems 104. Customer systems 152 may receive E-data and L-data from a group of sensors systems and decide to request a dynamic reconfiguration of a sensor based distributed processing system to achieve a particular data collection objective. A sensor based distributed processing system may be configured in response to an emergency in a particular location by retrieving L-data from database 205 and selecting sensor systems that would best provide E-data corresponding to the location relevant to the emergency. A specific client systems (e.g., 108) with coupled sensor systems (240A-240C) may be a wireless system with a wireless connection 118 to network 102. A customer system 152 may send a request to such a wireless system to move to a specific location to gather pertinent data for a task or an emergency. Likewise, a sensor system (e.g., 240A) may be a wireless system with a wireless connection 320A to client system 108. Sensor system 240A may be coupled to an L-sensor so that its location is known if it moves. In this case, client system 108 may receive a request to move sensor system 240A to a particular location to gather pertinent data for a task or an emergency.

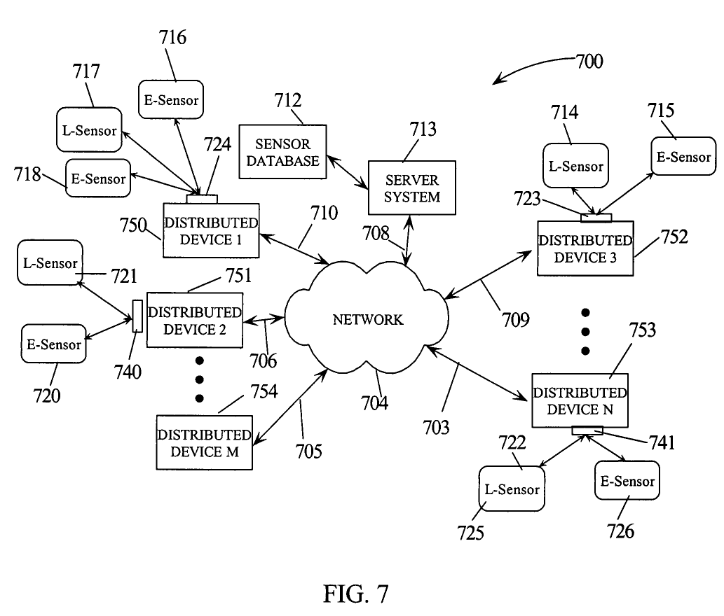

FIG. 7 illustrates a sensor based distributed processing system 700 according to embodiments of the present invention. M distributed devices 750-754 are shown coupled to server system 713 through network 704. Server system 713 has provided incentives for selected distributed devices to process workloads for a distributed processing system. N distributed devices 750-753 that have a port (e.g., 723) capable of coupling to at least one location sensor (L-sensor) and one environmental sensor (E-sensor) have accepted an incentive to form a sensor based distributed processing system by adding a least one E-sensor and means for acquiring L-data (e.g., from an L-sensor). Distributed device 719 has two E-sensors 716 and 718. The L-sensors (e.g., GPS) provide location data identifying the location of a particular distributed device relative to server system 713. The E-sensors generate environmental data (E-data) including but not limited to temperature, humidity, video image of surroundings, etc., relative to the particular distributed device to which it is coupled. E-data may also include data for identification of a human (e.g., fingerprint data or electronic ID data) or a property item (e.g., bar code data or electronic tag data). E-sensors also provide sensor identification (sensor ID) data that is readable which identifies its sensor type. Server system 713 has software that is capable of sending to each participating distributed device a sensor software agent that is capable of sampling location sensor data (L-data), environment sensor data (E-data), as well as the corresponding sensor ID data and sending it to the server system in response to a request from the server system 713. Server system 713 stores any available E-data, L-data, and sensor ID data for all of the distributed devices (850-854) in sensor database 712. Server system 713 has software that may either automatically or with a user input, manually, configure a sensor based data collection system by selecting N of the distributed devices with desired locations (L-data) and E sensors in response to analyzing the data stored in sensor database 712. Server system 713 may offer incentives to the distributed devices to add specific sensors to upgrade their potential for participating in sensor based distributed processing and data collection in the future. Distributed devices 750-754 may be wireless and still be within the scope of the present invention.

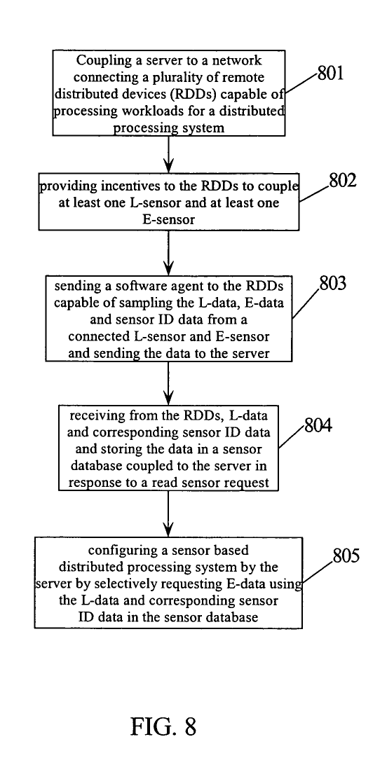

FIG. 8 is a flow diagram of method steps used in embodiments of the present invention. In step 801, a server system is coupled to a network connecting a plurality of remote distributed devices (RDDs) capable of processing workloads for a distributed processing system. In step 802, the server system provides incentives to the RDDs to couple at least one environmental sensor (E-sensor) and to provide L-data corresponding to the location of the RDD (e.g. from a L-sensor). In step 803, the server system sends a software agent to the RDDs capable of sampling the L-data and E-data and sensor ID data from the connected E-sensor and sending the data to the server system. In step 804, the server system requests and receives from the RDDs, L-data, and corresponding sensor ID data and stores the data in a sensor database coupled to the server system. In step 805, the server system configures a sensor based distributed processing system by requesting E-data from selected RDDs using the L-data and corresponding sensor ID data in the sensor database.

Further modifications and alternative embodiments of this invention will be apparent to those skilled in the art in view of this description. It will be recognized, therefore, that the present invention is not limited by these example arrangements. Accordingly, this description is to be construed as illustrative only and is for the purpose of teaching those skilled in the art the manner of carrying out the invention. It is to be understood that the forms of the invention herein shown and described are to be taken as the presently preferred embodiments. Various changes may be made in the implementations and architectures for database processing. For example, equivalent elements may be substituted for those illustrated and described herein, and certain features of the invention may be utilized independently of the use of other features, all as would be apparent to one skilled in the art after having the benefit of this description of the invention.

Although the present invention and its advantages have been described in detail, it should be understood that various changes, substitutions and alterations can be made herein without departing from the spirit and scope of the invention as defined by the appended claims.

What is claimed is:

1. A distributed processing system having sensor based data collection comprising:
a server system coupled to a network, wherein the network is configurable for of coupling to distributed devices for processing workloads for the distributed processing system;
one or more remote distributed devices (RDDs) selected from within the distributed devices and accessible to the server system in response to an incentive provided by the server system, each of the RDDs having an input/output (I/O) port for coupling at least one environmental sensor (E-sensor) generating environmental data (E-data) corresponding to the RDDs, wherein the E-data includes sensor identification (ID) data identifying the E-sensor's corresponding type;
a software agent operating within each of the RDDs for sending location data (L-data) corresponding to a location of the RDD, the E-data, and corresponding sensor ID data to the server system in response to a received read sensor request;
a sensor database coupled to the server system for storing L-data, E-data and corresponding sensor ID data; and
a software program executable by the server system for configuring one or more sensor based data collection systems in response to user requests using the L-data and corresponding sensor ID data in the sensor database.

2. The distributed processing system of claim 1, wherein L-data and E-data are communicated to a customer system subscribing to a sensor based data service hosted by the server system.

3. The distributed processing system of claim 1, wherein a time the read sensor request is sent and a time corresponding E-data, L-data and sensor ID data are received in the server system are stored by the server system.

4. The distributed processing system of claim 1, wherein selected ones of the RDDs are wireless RDDs capable of mobile communication with the server system.

5. The distributed processing system of claim 4, wherein a wireless RDD receives a request to move to a selected location to provide particular data collection for the server system.

6. The distributed processing system of claim 5, wherein the request to move the wireless RDD is in response to an emergency condition within or near the selected location.

7. The distributed processing system of claim 1, wherein an E-sensor and a location sensor (L-sensor) generating L data for an RDD are wireless sensors physically coupled and mobile and having a wireless connection to the RDD.

8. The distributed processing system of claim 2, wherein the customer system subscribing to the sensor based data service hosted by the server system may directly request E-data from selected RDDs using L-data and corresponding sensor ID data in the sensor database.

9. The distributed processing system of claim 1 further comprising a distributed device performance capabilities database coupled to the server system, wherein L-data and E-data of RDDs are stored with performance capabilities data for the RDDs.

10. The distributed processing system of claim 1, wherein the L-data is generated by an L-sensor coupled to each of the RDDs.

11. The distributed processing system of claim 10, wherein the L-sensor is a global positioning system (GPS) sensor.

12. The distributed processing system of claim 1, wherein L-data is determined from a mailing address of a facility housing a corresponding RDD.

13. The distributed processing system of claim 1, wherein L-data is determined from a network address of a corresponding RDD.

14. The distributed processing system of claim 1, wherein a first sensor based data collection system within the one or more sensor based data collection systems is dynamically reconfigured in response to a user analyzing previously received L-data and E-data for the first sensor based data collection system.

15. The distributed processing system of claim 1, wherein a user sends a sensor request to a particular RDD to add a first E-sensor in response to analyzing previously received L-data and E-data for a first sensor based data collection system within the one or more sensor based data collection systems.

16. The distributed processing system of claim 1, wherein the E-sensor is selected from a class of sensors for quantifying any parameter that may be related to people, property or physical conditions in an area in proximity to and including an RDD.

17. The distributed processing system of claim 1, wherein the E-sensor is selected from a set of sensors consisting of biometrics detection sensors, early warning network sensors, network intrusion sensors, radio frequency (RD) identification transmitters and receivers, and system security sensors used to allow access to other services supplied by the RDD or to monitor general activity at the RDD.

18. A method of forming a distributed processing system having sensor based data collection comprising:
coupling a server system to a network connecting a plurality of remote distributed devices (RDDs) capable of processing workloads for a distributed processing system, wherein each of the RDDs has at least one input/output (I/O) port for coupling a plurality of sensors;
providing an incentive for the RDDs to couple at least one environmental sensor (E-sensor) generating E-data corresponding to the RDDs and to provide location data (L-data) corresponding to an identifiable location of the RDD, wherein the E-data includes sensor ID data identifying the type of the E-sensor;
executing a software agent in the RDDs, the software agent capable of sending the L-data, E-data and corresponding sensor ID data to the server system in response to a read sensor request;
receiving the L-data and sensor ID data from the RDDs and storing the L-data and sensor ID data in a sensor database coupled to the server system; and
configuring the distributed processing system having sensor based data collection by requesting and collecting E-data from selected RDDs, wherein the RDDs are selected using the L-data and corresponding sensor ID data in the sensor database.

19. The method of claim 18, wherein L-data and E-data are communicated to a customer system subscribing to sensor based data service hosted by the server system.

20. The method of claim 18, wherein a time the read sensor request is sent and a time corresponding E-data, L-data and sensor ID data are received in the server system are stored by the server system.

21. The method of claim 18, wherein the L-data is generated by a L-sensor coupled to each of the RDDs.

22. The method of claim 21, wherein the L-sensor is a global positioning system (GPS) sensor.

23. The method of claim 18, wherein the L-data is determined from an address of a facility housing a corresponding RDD.

24. The method of claim 18, wherein L-data is determined from a network address of a corresponding RDD.

25. A server system coupled to a network, wherein the network is configurable for of coupling to one or more remote distributed devices (RDDs), each of the RDDs having at least one input/output (I/O) port for coupling a location sensor (L-sensor) for generating location data (L-data) corresponding to a location of the RDD and at least one environmental sensor (E-sensor) generating environmental data (E-data) corresponding to the RDDs, wherein the E-data includes sensor ID data identifying the E-sensor's corresponding type comprising:
a sensor database coupled to the server system for storing L-data, E-data and corresponding sensor ID data; and
a software program executable by the server system for configuring one or more sensor based data collection systems in response to user requests using the L-data and corresponding sensor ID data in the sensor database.

26. A software agent executable within a remote distributed device (RDD) coupled to a server system through a network comprising a program of instructions for implementing the steps of:
receiving a read sensor command from the server system;
reading environmental data (E-data) from one or more environmental sensors (E-sensors) coupled to the RDD in response to the read sensor command, wherein the E-data includes sensor identification (ID) data identifying the E-sensor's corresponding type comprising;
reading location data (L-data) corresponding to a location of the RDD in response to the read sensor command; and
sending E-data, corresponding sensor ID data and L-data to the server system.

27. The software agent of claim 26 further comprising an instruction to receive an incentive from the server system to couple one or more E-sensors to the RDD and to provide the L-data.

28. A computer program executable within a server system coupled to a network, wherein the network is configurable for coupling to a plurality of remote distributed devices (RDD) for processing workloads for the distributed processing system comprising a program of instructions for implementing the steps of:
providing an incentive for the RDDs to couple at least one environmental sensor (E-sensor) generating E-data corresponding to the RDDs and to provide location data (L-data) corresponding to an identifiable location of the RDD, wherein the E-data includes sensor ID data identifying the type of the E-sensor;
sending a read sensor request to the selected ones of the RDDs, wherein the selected ones of the RDDs send E-data, sensor ID data and L data in response to the read command;
storing the E-data, sensor ID data, and L-data in a sensor database accessible by the server system;
receiving a request from a client system to configure a remote sensor based data collection system having a desired geographical area of coverage;
reading L-data and corresponding sensor ID data from the sensor database and selecting one or more candidate RDDs having a desired type of E-sensor and locations corresponding to the desired geographical area of coverage;
sending the read sensor request to each of the one or more candidate RDDs at a sample time;
receiving E-data, corresponding sensor ID data, and L-Data from the one or more candidate RDDs, wherein a receive data time is stored corresponding to when the E-data, corresponding sensor ID data, and L-Data are received; and
sending the E-data, corresponding sensor ID data, L-Data, and the corresponding sample time and receive data time to the client system sending the request to configure the remote sensor based data collection system.
